(19) United States
(12) Patent Application Publication
(10) Pub. No.: US 2020/0227837 A1
(43) Pub. Date: Jul. 16, 2020

(54) RECONFIGURABLE HYBRID ANTENNA FOR WIRELESS COMMUNICATION NETWORKS

(71) Applicant: Nokia Technologies Oy, Espoo (FI)

(72) Inventor: Heikki Mäkäräinen, Oulu (FI)

(73) Assignee: Nokia Technologies Oy, Espoo (FI)

(21) Appl. No.: 16/247,700

(22) Filed: Jan. 15, 2019

(51) Int. Cl. H01Q 21/28; H01Q 1/24; H01Q 5/20; H04B 7/06

(52) U.S. Cl. CPC H01Q 21/28; H04B 7/0617; H01Q 5/20; H01Q 1/243

(57) ABSTRACT

A reconfigurable hybrid antenna arrangement is provided that includes an antenna housing, a passive multiband antenna positioned within a first section of the antenna housing, and a passive multiple-input multiple-output (MIMO) antenna that supports 5G wireless services that is removably positioned within a second section in the antenna housing. The second section is reconfigurable such that the passive MIMO antenna can be replaced with a second MIMO antenna to support enhanced 5G services, e.g., to upgrade 5G capabilities, and the replacement MIMO antenna utilizes existing space within the same antenna housing. In this manner, existing antenna structures that include a passive antenna array for supporting legacy wireless services can be reconfigured by adding another antenna to support network upgrades for new wireless services and doing so within the existing antenna structure to obviate any site-related issues, e.g., lack of available space and antenna size restrictions.

### TECHNICAL FIELD

The present invention relates generally to antennas, and more particularly to a reconfigurable hybrid antenna arrangement that provides network upgrade flexibility while preserving operational capability across multiple wireless communication services and standards.

### BACKGROUND

With the acceleration of fifth generation (5G) standardization and commercialization, mobile network operators are faced with the challenge of upgrading networks to support 5G wireless service while also supporting the embedded base of existing and still evolving wireless services (e.g., 3G, 4G LTE, etc.), and doing so in a cost-effective and non-disruptive manner. One particular concern for network operators is the potential costly replacement of antennas to support new wireless services at multiple sites throughout their networks.

For example, massive multiple-input multiple-output (mMIMO) antenna technology will likely be a core component for 5G networks because of the significantly increased capacity provided by the increased number of antennas compared to today's MIMO implementations. However, upgrading to mMIMO can be very expensive, so network operators will need to manage costs and timing of network upgrades, taking into consideration how much capacity will be needed, and when, to serve the demand that may gradually increase over time.

In addition to cost implications, site-related limitations also are a primary consideration for upgrading networks. Crowded cell towers, the scarcity of new sites in densely populated areas, and strict site leasing requirements make it very difficult for mobile operators to acquire new sites to install antennas or to increase the number or size of antennas at existing installations.

### SUMMARY

These and other issues are addressed, in accordance with the various embodiments, with a reconfigurable hybrid antenna arrangement that includes an antenna housing having a first section and a second section proximal to the first section and a passive multiband antenna positioned within the first section of the antenna housing. The reconfigurable hybrid antenna arrangement is configured to adopt a first configuration in which a first passive multiple-input multiple-output (MIMO) antenna apparatus for supporting 5G wireless services is removably positioned within the second section in the antenna housing. According to an embodiment, the reconfigurable hybrid antenna arrangement is further configured to adopt a second configuration in which a second MIMO antenna apparatus for supporting 5G wireless services, and which is of a different type than the first passive MIMO antenna apparatus, is removably positioned within the second section of the antenna housing to replace the first passive MIMO antenna apparatus and fit in an existing space within the same antenna housing. As such, issues related to site limitations or restrictions (e.g., available or allowed space, site lease restrictions, etc.) can be obviated. The reconfigurable aspects of the antenna arrangement also provide a solution for network operators to more effectively manage costs of network equipment upgrades.

According to various embodiments, the first passive MIMO antenna apparatus may be arranged as a kTpR array, where k is an integer greater than or equal to 8 that corresponds to the number of transmit antennas in the array and p is an integer greater than or equal to 8 that corresponds to the number of receive antennas in the array, e.g., an 8T8R MIMO array. The first MIMO antenna may be a passive antenna array and may be further coupled to a radio external to the antenna housing. The second MIMO antenna apparatus, which would be substituted for the first MIMO antenna in the antenna housing, may be an mTnR antenna array, wherein m is an integer greater than or equal to 8 that corresponds to the number of transmit antennas and n is an integer greater than or equal to 8 that corresponds to the number of receive antennas, and wherein m does not equal k and n does not equal p. In one embodiment, the second MIMO antenna may be an active antenna array coupled to a 5G radio within the antenna housing. In another embodiment, the second MIMO antenna may be a mMIMO active antenna (MAA) array. As such, various replacement or upgrade combinations are contemplated in the various embodiments. For example, the first MIMO antenna may be a passive antenna array and replaced by a second MIMO antenna that is another passive antenna array, an active antenna array or a mMIMO antenna array.

### BRIEF DESCRIPTION OF THE DRAWINGS

FIG. 1A shows a back view of a simplified block diagram of a reconfigurable hybrid antenna arrangement in accordance with an illustrative embodiment;

FIG. 1B shows a side view of the reconfigurable hybrid antenna arrangement shown in FIG. 1A;

FIG. 2A shows a front view of a simplified block diagram of a reconfigurable hybrid antenna arrangement in accordance with an illustrative embodiment;

FIG. 2B shows a side view of the reconfigurable hybrid antenna arrangement shown in FIG. 2A;

FIG. 2C shows a front view of a simplified block diagram of the reconfigurable hybrid antenna arrangement from FIG. 2A, and further showing an upgrade example in accordance with an illustrative embodiment; and

FIG. 2D shows a side view of the reconfigurable hybrid antenna arrangement shown in FIG. 2C.

### DETAILED DESCRIPTION

Various illustrative embodiments will now be described more fully with reference to the accompanying drawings in which some of the illustrative embodiments are shown. It should be understood, however, that there is no intent to limit illustrative embodiments to the particular forms disclosed, but on the contrary, illustrative embodiments are intended to cover all modifications; equivalents; and alternatives falling within the scope of the claims. Like numbers refer to like elements throughout the description of the figures. It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of illustrative embodiments. As used herein; the term “and/or” includes any and all combinations of one or more of the associated listed items. The term 5G, as used herein, is meant to refer to the next generation (i.e., fifth generation) of mobile networks as specified by the International Telecommunications Union—Radiocommunication Sector (ITU-R), which is well known to those of ordinary skill in the art. Similarly, the terms 3G, 4G, 4G LTE and LTE Advanced are all well-known terms having meanings and definitions that are well understood by those skilled in the art of wireless communications.

As indicated, the high cost of swapping out antennas and the constraints at antenna sites for expanding or changing out antennas are two principle concerns of network operators with regard to the migration and build-out of 5G networks. Furthermore, in the case of 5G network build-outs, the demand in early phases will likely not warrant or justify all the up-front investment for the capacity provided by mMIMO. A full-scale migration to mMIMO, for example, will not only be costly, but will likely be inefficient for managing capacity to demand, especially in the early phases of 5G implementation. As such, there is a need for a cost-effective solution that provides operators with the flexibility to implement network equipment upgrades in a phased approach to support the rollout of 5G wireless capability while still maintaining support for legacy services. Additionally, with limited availability of new antenna sites, especially in urban areas, and with the overcrowding at existing sites, network operators need a better solution for upgrading current antenna installations within the constraints of their site leasing parameters.

Many installed antenna structures include multiband antennas that utilize passive antenna arrays, which are well known to those skilled in the art. Such antenna arrays are known to support current wireless services operating in several bands, e.g., from about 690 MHz to about 960 MHz, from about 1400 MHz to about 2400 MHz, and from about 1710 MHz to about 2690 MHz. These aforementioned frequency bands are meant to be illustrative only as other exemplary bands will also be well-known to those skilled in the art. For purposes of discussion herein, the passive multiband antennas will be referred to in the context of supporting legacy bands.

One approach for upgrading an existing antenna structure to support the launch of 5G services, for example, would be to fabricate a new antenna structure that adds a mMIMO active array (MAA) for supporting 5G services to an antenna housing containing a passive multiband structure for legacy bands. Such an antenna structure could be swapped in for the existing antenna structure installed at the site. As described, a full mMIMO solution for an early phase 5G build-out is a costly investment and would provide more capacity than what will actually be needed to satisfy the likely service demands in the early phases of 5G implementation. Moreover, stacking a mMIMO active array and associated components onto the existing passive multiband structure would not conform to the existing antenna's form factor (e.g., size, shape, etc.). For example, stacking a mMIMO active array in combination with a passive multiband array can add approximately one (1) meter to the length (or height) of the antenna structure, which is unacceptable at many antenna sites that have strict size and space constraints. Attempting to reduce the length of the passive multiband portion as a work-around to accommodate the addition of the mMIMO active array within the existing form factor is not feasible because of the impact to the low band gain performance of the passive multiband antenna for the legacy bands. Other options, such as adding a MIMO array in a fixed arrangement onto an existing antenna structure suffers other drawbacks, such as not providing mobile network operators with upgrade flexibility.

In accordance with the various embodiments, a reconfigurable hybrid antenna arrangement provides a cost-effective upgrade solution to enable new wireless services (e.g., 5G) while maintaining support for legacy wireless services (e.g., 3G, 4G, etc.). The reconfigurable hybrid antenna is reconfigurable such that antenna elements can be upgraded and replaced while utilizing the existing space within the antenna structure. In this manner, existing antenna structures that include a passive antenna array for supporting legacy wireless services can be reconfigured by adding another antenna apparatus to support network upgrades for new 5G wireless services.

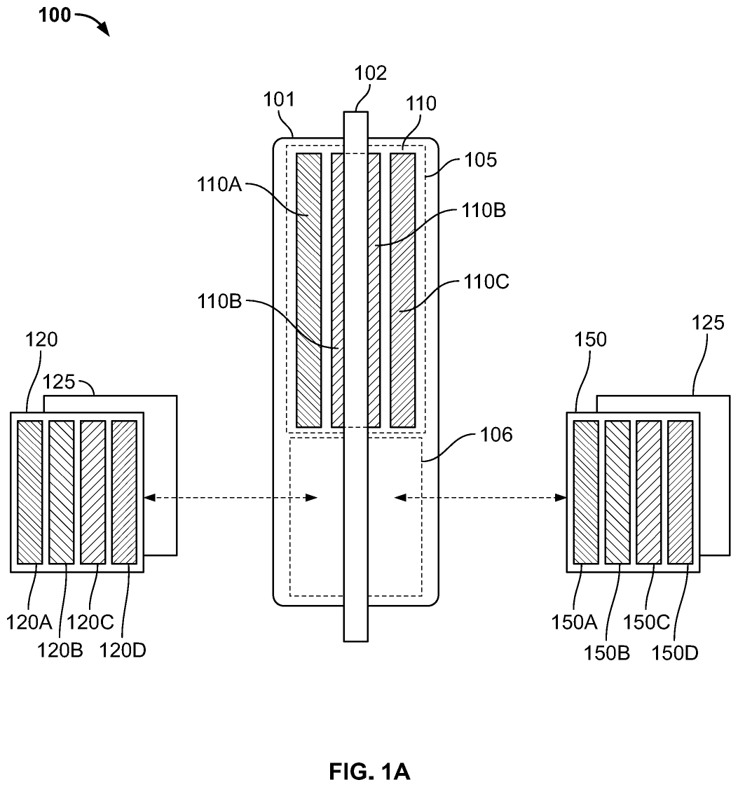

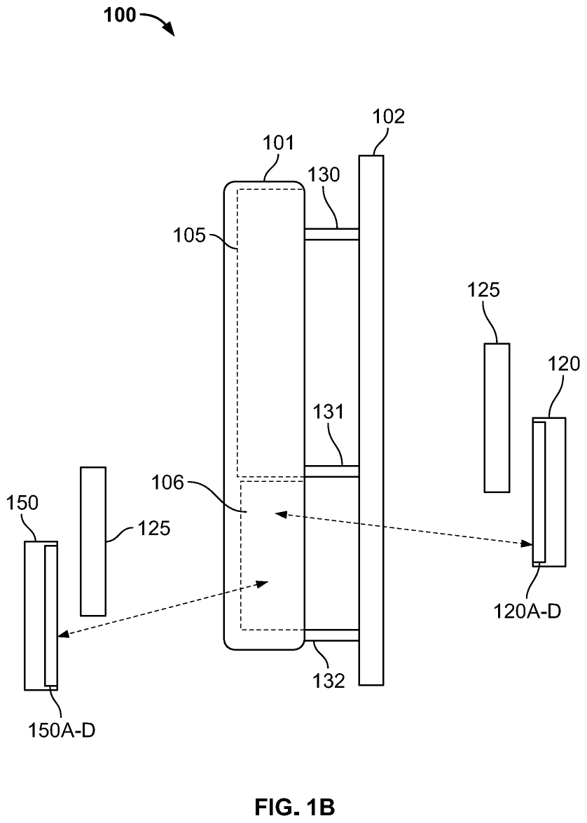

FIG. 1A shows a block representation of a back view of an antenna arrangement according to an illustrative embodiment. In particular, FIG. 1A shows reconfigurable hybrid antenna arrangement 100, which includes antenna housing 101. Antenna housing 101 may be attached to a suitable mount, shown here as antenna mount 102. Those skilled in the art will readily appreciate the various conventional mounting arrangements that are used in the field and which can be suitably used for antenna mount 102 in connection with the various embodiments disclosed herein. Various types of antenna housing designs (e.g., size, shape, materials, etc.), also referred to as enclosures, radomes, chassis, frames and other equivalent structures can be suitably used for antenna housing 101 in the various embodiments disclosed herein. Within antenna housing 101, first section 105 and second section 106 are shown to represent relative locations within antenna housing 101 in which antenna arrays can be positioned according to various embodiments. First and second sections 105 and 106, respectively, are proximal to each other and are shown to be separate, but also may have overlapping portions as will be described in more detail below for other embodiments. The specific location, shape, spacing, overlap or non-overlap, and/or delineations of first and section sections 105 and 106 shown in FIG. 1A are not at all meant to be limiting, but rather drawn in a simplified manner for ease of illustration. Those skilled in the art will appreciate that specific antenna designs will vary and will thus control the actual spacing and/or location of various components and elements within antenna housing 101 according to the described embodiments.

As further shown in FIG. 1A, a passive multiband antenna array 110 is situated in first section 105 of antenna housing 101. Passive multiband antenna array 110 is shown in simplified form to include passive elements and/or components 110A, 1106 and 110C. However, this simplified representation is not meant to be limiting, but only to illustrate that typical passive multiband antenna arrays will typically include a plurality of antenna elements, arrays, components in varying layouts and combinations to support communications across multiple frequency bands. Moreover, elements in a passive multiband antenna array do not need to be of the same type or structure. As will be appreciated by those skilled in the art, passive multiband antenna arrays are ubiquitous in that they are deployed and utilized at various antenna sites to support today's mobile communication networks, e.g., 3G and 4G networks. For example, various types of multiband antenna array arrangements are currently installed at antenna sites to support wireless communications operating in several bands, e.g., from about 690 MHz to about 960 MHz, from about 1400 MHz to about 2400 MHz, and from about 1710 MHz to about 2690 MHz.

Returning to FIG. 1A, reconfigurable hybrid antenna arrangement 100 is configured to adopt a first configuration in which a first passive multiple-input multiple output (MIMO) antenna structure 120 is removably positioned in second section 106 within antenna housing 101. MIMO antenna structure 120 is shown in simplified form to include elements and/or components 120A, 120B, 120C and 120D. However, this simplified representation is not meant to be limiting by number or type of elements/components, but only to illustrate that MIMO-based antenna arrays may include a plurality of antenna elements, arrays, components in varying layouts and combinations. It is contemplated in various embodiments that MIMO antenna structure 120 is a kTpR antenna array, where k is an integer greater than or equal to 8 that corresponds to the number of transmit antennas in the MIMO array and p is an integer greater than or equal to 8 that corresponds to the number of receive antennas in the MIMO array. In one illustrative embodiment, MIMO antenna structure 120 can be an 8T8R antenna array, with eight (8) transmit antennas and eight (8) receive antennas in the MIMO array to provide an antenna structure suitable for supporting 5G wireless services, e.g., including but not limited to 5G startup capability, etc.

Importantly, first MIMO antenna structure 120 is removable from within antenna housing 101 (as shown by the dotted arrow) to allow for upgrades to reconfigure hybrid antenna arrangement 100 to meet increasing 5G service demands, while only utilizing the existing space (e.g., fit in an existing space) inside of antenna housing 101 that still houses passive multiband antenna array 110. For example, reconfigurable hybrid antenna arrangement 100 is further configured to adopt a second configuration in which a second MIMO antenna structure 150, which is of a different type than first MIMO antenna structure 120, is removably positioned in second section 106 within antenna housing 101 to replace first MIMO antenna structure 120. In this manner, a mobile network operator would be able to upgrade to a different type of MIMO antenna structure to fit in a space within the same antenna housing 101 to provide more robust 5G capability if and as needed. This reconfigurability provides a mobile network operator with the flexibility to cost-effectively manage its 5G upgrade strategy, e.g., to support 5G implementation in a phased manner and without the need to start with a full scale implementation of a costly massive MIMO (mMIMO) solution.

For example, a mobile network operator may start with an 8T8R MIMO passive antenna array as first MIMO antenna structure 120 to provide initial start-up 5G capability and then subsequently replace the removable 8T8R MIMO passive array with second MIMO antenna structure 150 (as shown by the dotted arrows), e.g., which may include, in certain embodiments, mMIMO implementations such as 16T16R, 32T32R, 64T64R arrays and so on. In this context, MIMO antenna structure 150 is therefore contemplated to be an mTnR antenna array, where m is an integer greater than or equal to 8 that corresponds to the number of transmit antennas in the MIMO array and n is an integer greater than or equal to 8 that corresponds to the number of receive antennas in the MIMO array, and wherein m is not equal to k and n is not equal to p. Second MIMO antenna structure 150 is shown in simplified form to include elements and/or components 150A, 150B, 150C and 150D. However, this simplified representation is not meant to be limiting by number or type of elements/components, but only to illustrate that typical MIMO-based antenna arrays may include a plurality of antenna elements, arrays, components in varying layouts and combinations. In this manner, a mobile network operator is able to continue supporting legacy bands with passive multiband antenna array 110 while also having the flexibility to modify reconfigurable hybrid antenna arrangement 100 to provide support for 5G service according to a phased upgrade strategy. And again, the same antenna housing 101 is utilized so there is no change in size (e.g., height, length, etc.), which could otherwise create an issue for mobile network operators and their antenna site leasing agreements.

According to another aspect of the various embodiments, first and second MIMO antenna structures 120 and 150, respectively, may be passive and/or active arrangements in different combinations, as will be appreciated by those skilled in the art. In one example, first MIMO antenna structure 120 may be a passive array coupled, e.g., via a coaxial-cabled RF connection, to a radio apparatus that is external to antenna housing 101. Alternatively, first MIMO antenna structure 120 may be an active array with a radio apparatus within antenna housing 101. Similarly, second MIMO antenna structure 150 may also be a passive or active array and coupled to radio apparatus in any of the above-mentioned combinations.

In one illustrative embodiment, reconfigurable hybrid antenna arrangement 100 includes an 8T8R MIMO passive array, as element 120, incorporated inside antenna housing 101 along with passive multiband antenna array 110, wherein the 8T8R MIMO passive array is coupled via a cabled connection to a radio apparatus that is external to antenna housing 101. As a subsequent upgrade, by way of example, the 8T8R MIMO passive array may be replaced by a mMIMO active array (MAA), as element 150, with an integrated 5G radio (also commonly referenced as a 5G New Radio (NR)). Various upgrade scenarios involving MIMO antenna structures 120 and 150 are contemplated in the various embodiments, e.g., replacing a passive array with an active array, an active array with another type of active array, a passive array or an active array with a mMIMO active array (MAA), and other variations and combinations. The foregoing further illustrates the added flexibility available to mobile network operators in terms of being able to effectively manage costs and operational requirements during upgrades. With these embodiments, a mobile network operator has the flexibility to roll out 5G services in a cost-effective staged approach. As indicated, a network operator can initially utilize an 8T8R MIMO passive array with a separately cabled 5G NR radio that provides 5G capability as a lower cost startup solution. Subsequently, the network operator may replace the initial configuration with an active MIMO or mMIMO active array (MAA) solution as a future upgrade, thereby effectively deferring some of the higher upgrade costs until increased capacity is actually needed in the network.

FIG. 1B shows a block representation of a side view of the reconfigurable hybrid antenna arrangement 100 from FIG. 1A, with elements designated by the same reference numerals as appropriate. In particular, FIG. 1B shows antenna housing 101, which includes first section 105 and second section 106, mounted onto antenna mount 102 via mounting structures 130, 131 and 132. Again, those skilled in the art will readily appreciate the various mounting methods and apparatus used for mounting such antennas at antenna sites. FIG. 1B also shows a side view of MIMO antenna structure 120 with elements 120A-120D and MIMO antenna structure 150 with elements 150A-150D, as previously described. For ease of reference, FIG. 1B is intended to provide another view on the incorporation of MIMO antenna structures 120 and 150 into antenna housing 101.

In both FIGS. 1A and 1B, optional sealing structure 125 can be used to secure and/or provide some sealing functions for the insertion and placement of MIMO antenna structures 120 and 150 into antenna housing 101. Use of sealing structure 125 or another equivalent structure or technique for securing and protecting components in an antenna housing will be readily apparent to those skilled in the art. For example, sealing structure 125 can provide protection against adverse environmental conditions and other undesirable external conditions, among other functions.

As previously described for various embodiments, first and second sections 105 and 106, respectively, are proximally located to each other but can be separate locations within antenna housing 101. In other embodiments, first and second sections 105 and 106 may have overlapping portions such that passive multiband antenna array 110 and MIMO antenna structure 120 may be positioned within antenna housing 101 in an overlapping and/or interleaved arrangement. For example, each of passive multiband antenna array 110 and MIMO antenna structure 120 include radiating antenna elements. In an interleaved arrangement, at least some of the radiating elements of MIMO antenna structure 120 may be interleaved or situated amongst (e.g., within interstices) at least some of the radiating elements of passive multiband antenna array 110. Similarly, as part of an upgrade, passive multiband antenna array 110 and MIMO antenna structure 150 may be positioned within antenna housing 101 in an interleaved arrangement in a similar manner as described above. The amount or extent of overlap and/or interleaving is a matter of design choice.

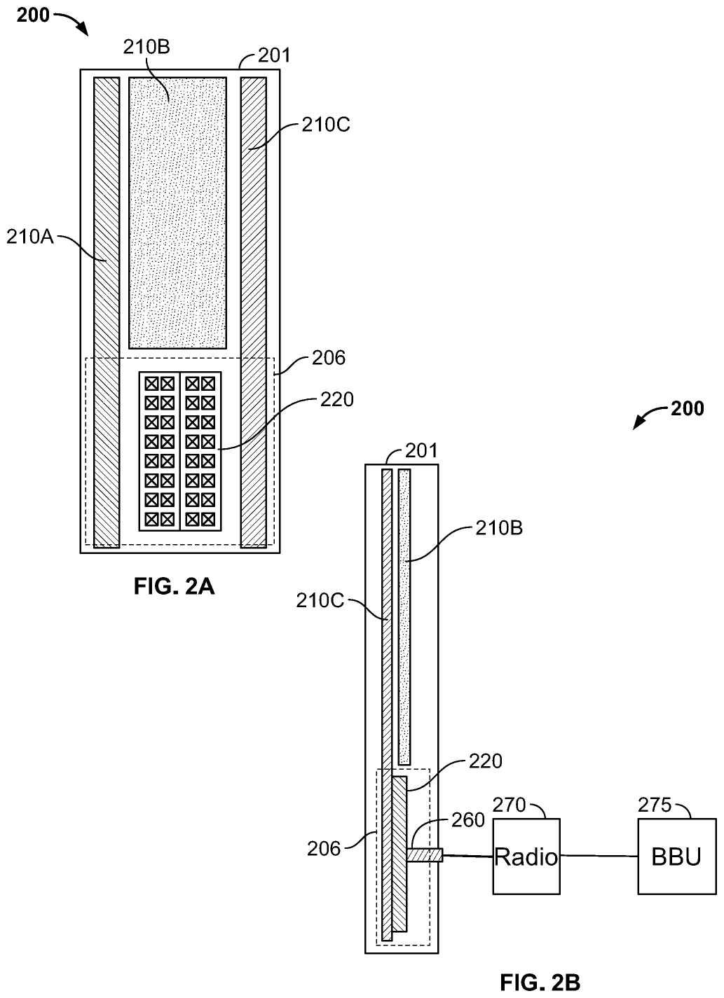

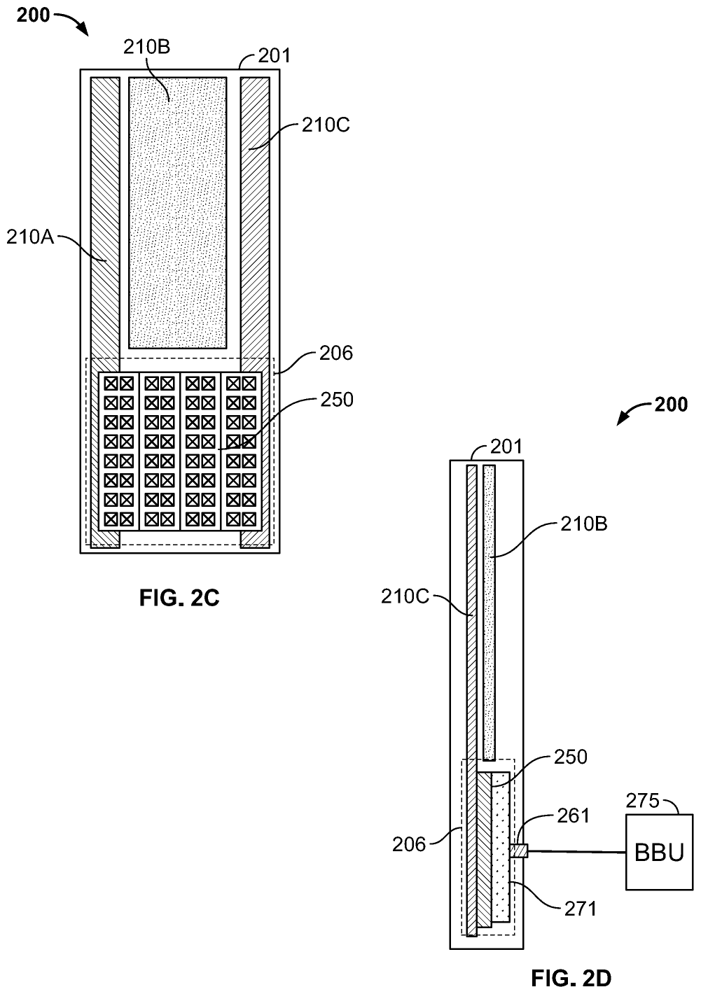

FIGS. 2A through 2D show another embodiment of a reconfigurable hybrid antenna arrangement 200, with elements designated by the same or similar reference numerals as appropriate. In FIG. 2A, antenna housing 201 includes passive multiband antenna elements 210A, 210B and 210C for supporting legacy bands. Similar to the arrangement shown in FIGS. 1A and 1B, antenna housing 201 further includes a MIMO antenna structure 220 for supporting 5G services, situated in section 206. In this example, MIMO antenna structure 220 is shown as a 4-column 8T8R passive antenna array for illustrative purposes. Importantly, and as similarly described in the foregoing embodiments, MIMO antenna structure 220 is removable from within antenna housing 201 to allow for upgrades to reconfigure hybrid antenna arrangement 200 to meet increasing 5G service demands, while only utilizing the existing antenna housing 201 that still houses passive multiband antenna elements 210A, 210B and 210C.

FIG. 2B shows a side view of reconfigurable hybrid antenna arrangement 200 from FIG. 2A. As shown, MIMO antenna structure 220 is further coupled to external radio 270 via a cabled connection, e.g., a coaxial-cabled connection utilizing RF connector(s) 260 on antenna housing 201. For example, radio 270 can be a 5G radio (NR) as described in preceding embodiments. Radio 270 is further coupled to Base Band Unit (BBU) 275 to operate in a manner well known to those skilled in the art.

FIGS. 2C and 2D further illustrate the reconfigurability aspects of hybrid antenna arrangement 200. As shown in FIG. 2C, a second MIMO antenna structure 250 is swapped in for MIMO antenna structure 220 (from FIGS. 2A and 2B) in reconfigurable section 206 of antenna housing 201. In this embodiment, MIMO antenna structure 250 is shown as an 8-column mMIMO active antenna (MAA) array for illustrative purposes. FIG. 2D further shows radio 271 (e.g., 5G NR) coupled to second MIMO antenna structure 250 inside antenna housing 201 for a fully integrated solution. Radio 271 is further coupled to Base Band Unit (BBU) 275 to operate in a manner well known to those skilled in the art. For example, BBU 275 and 5G radio 271 can be coupled via a common public radio interface, e.g., an optical CPRI or eCPRI connection, utilizing connector(s) 261 on antenna housing 201.

The form factor of an antenna housing (e.g., size, shape and dimensions, including but not limited to height, length, width, volume, weight, etc.) is typically governed by site leasing agreements that set forth allowances and/or restrictions. As such, for purposes of the embodiments disclosed herein, the particular details of the form factor, such as any particular dimensions for antenna housings 101 (and 201) will vary according to antenna site considerations, application, design choice, and so on. The important aspect about form factor as it relates to the embodiments disclosed herein is that any reconfiguration, modification, substitution and/or replacement of antenna components for reconfigurable hybrid antenna arrangement 100 (and 200) conforms to the existing form factor (e.g., utilizing existing space) of antenna housing 101 (and 201). In particular, reconfigurable hybrid antenna arrangement 100 (and 200) provides a solution for mobile network operators to upgrade components to support new wireless services by utilizing existing antenna structures that already comply with site-related requirements and restrictions. Consequently, the embodiments disclosed herein enable mobile network operators to avoid issues and costs that may otherwise be encountered with other solutions that entail replacing or adding new antenna structures that alter the form factor (e.g., increase the length or height) of the existing installations.

It should be noted that the embodiments shown and described herein are not meant to be limiting in any way with regard to the location or positioning of passive multiband antenna array 110 (and 210) and MIMO antenna structures 120 and 150 inside antenna housing 101 (or MIMO antenna structures 220 and 250 inside antenna housing 201). Various combinations are contemplated to be included within the spirit and scope of the present disclosure, e.g., some of which may be dictated, warranted or preferred by design choice, available spacing within the existing antenna structures, and/or other factors. For example, various stacking (vertically or horizontally), overlapping and/or interleaving arrangements may be utilized or a combination of any of these arrangements.

The foregoing merely illustrates the principles of the disclosure. It will thus be appreciated that those skilled in the art will be able to devise various arrangements that, although not explicitly described or shown herein, embody the principles of the disclosure and are included within its spirit and scope. Furthermore, all examples and conditional language recited herein are principally intended to be only for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future.

What is claimed is:

1. A reconfigurable hybrid antenna arrangement, comprising:
an antenna housing including a first section and a second section proximal to the first section;
a passive multiband antenna apparatus positioned within the first section of the antenna housing;
wherein the reconfigurable hybrid antenna arrangement is configured to adopt:
a first configuration in which a first passive multiple-input multiple-output—MIMO—antenna apparatus for supporting fifth generation—5G—wireless services is removably positioned within the second section of the antenna housing, and
a second configuration in which a second multiple-input multiple-output—MIMO—antenna apparatus for supporting fifth generation—5G—wireless services is removably positioned within the second section of the antenna housing to replace the first passive MIMO antenna apparatus; and
wherein the second MIMO antenna apparatus is of a type which is different from the type of the first passive MIMO antenna apparatus.

2. The reconfigurable hybrid antenna arrangement of claim 1, wherein the first passive MIMO antenna apparatus is arranged as a kTpR array, where k is an integer greater than or equal to 8 that corresponds to a number of transmit antennas and p is an integer greater than or equal to 8 that corresponds to a number of receive antennas, and wherein the second MIMO antenna apparatus is arranged as an mTnR array, where m is an integer greater than or equal to 8 that corresponds to a number of transmit antennas and n is an integer greater than or equal to 8 that corresponds to a number of receive antennas, and wherein m is not equal to k and n is not equal to p.

3. The reconfigurable hybrid antenna arrangement of claim 2, wherein one of the first passive MIMO antenna apparatus and the second MIMO antenna apparatus is an 8T8R array.

4. The reconfigurable hybrid antenna arrangement of claim 1, wherein the first section is separate from the second section.

5. The reconfigurable hybrid antenna arrangement of claim 2, wherein the first passive MIMO antenna apparatus comprises a passive antenna array.

6. The reconfigurable hybrid antenna arrangement of claim 5, wherein the passive antenna array is coupled to a radio apparatus located external to the antenna housing.

7. The reconfigurable hybrid antenna arrangement of claim 2, wherein the second MIMO antenna apparatus comprises an active antenna array.

8. The reconfigurable hybrid antenna arrangement of claim 7, wherein the second MIMO antenna apparatus comprises a massive MIMO—mMIMO—active antenna array.

9. The reconfigurable hybrid antenna arrangement of claim 7, further comprising a 5G-capable radio apparatus, wherein the active antenna array is coupled to the 5G-capable radio apparatus within the antenna housing.

10. A reconfigurable hybrid antenna apparatus, comprising:
an antenna housing including a first section and a second section proximal to the first section; and
a passive multiband antenna apparatus positioned within the first section of the antenna housing;
wherein the reconfigurable hybrid antenna apparatus is configured to adopt:
a first configuration in which a first passive multiple-input multiple-output—MIMO—antenna apparatus for supporting fifth generation—5G—wireless services is removably positioned within the second section of the antenna housing, and wherein the first passive MIMO antenna apparatus is arranged as a kTpR passive array, where k is an integer greater than or equal to 8 that corresponds to a number of transmit antennas and p is an integer greater than or equal to 8 that corresponds to a number of receive antennas.

11. The reconfigurable hybrid antenna apparatus of claim 10, wherein the kTpR passive array is coupled to a radio apparatus located external to the antenna housing.

12. The reconfigurable hybrid antenna apparatus of claim 10, further configured to adopt:
a second configuration in which a second multiple-input multiple-output—MIMO—antenna apparatus for supporting fifth generation—5G—wireless services—is removably positioned within the second section of the antenna housing to replace the first passive MIMO antenna apparatus, wherein the second MIMO antenna apparatus fits in an existing space within the antenna housing, and wherein the second MIMO antenna apparatus is of a type which is different from the type of the first passive MIMO antenna apparatus.

13. The reconfigurable hybrid antenna apparatus of claim 12, further comprising a 5G-capable radio apparatus, wherein the second MIMO antenna apparatus is an active array coupled to the 5G-capable radio apparatus within the antenna housing.

14. The reconfigurable hybrid antenna apparatus of claim 12, wherein the second MIMO antenna apparatus is arranged as an mTnR array, where m is an integer greater than or equal to 8 that corresponds to a number of transmit antennas and n is an integer greater than or equal to 8 that corresponds to a number of receive antennas, and wherein m is not equal to k and n is not equal to p.

15. The reconfigurable hybrid antenna apparatus of claim 14, wherein one of the first passive MIMO antenna apparatus and the second MIMO antenna apparatus is an 8T8R array.

16. The reconfigurable hybrid antenna apparatus of claim 14, wherein the second MIMO antenna apparatus comprises a massive MIMO—mMIMO—active antenna array.
